(19) United States
(12) Patent Application Publication
(10) Pub. No.: US 2002/0050537 A1
(43) Pub. Date: May 2, 2002

(54) Nozzle apparatus of surface mounting device

(75) Inventor: Dong June Kim, Kyungki-do (KR)

Correspondence Address: FLESHNER & KIM, LLP, P.O. Box 221200, Chantilly, VA, 20153-1200, US

(73) Assignee: MIRAE CORPORATION

(21) Appl. No.: 09/983,745

(22) Filed: Oct. 25, 2001

(30) Foreign Application Priority Data
Oct. 27, 2000 (KR) 2000-63581

(51) Int. Cl. B05B 1/00

(52) U.S. Cl. 239/589; 239/600

(57) ABSTRACT

A nozzle apparatus of a surface mounting device is disclosed. The nozzle apparatus includes a socket portion in which a connection block is fixedly installed by an assembly block formed on the bottom of a hollow shaft, socket shafts are installed at both sides of the connection block and both ends of the socket shaft are connected by a plurality of elastic members, and a nozzle portion inserted into the socket portion and slidably mounted to the inside of the socket portion in a state of contacting with the socket shaft. The nozzle portion can be stably replaced with another to be mounted on the socket portion regardless of a repetitive error and an overshoot.

### BACKGROUND OF THE INVENTION

1. Field of the Invention

The present invention relates to a nozzle apparatus, and more particularly, to a nozzle apparatus which is capable of precisely replacing a nozzle portion for sucking parts for another when a surface mounting device carries surface mounting parts to a printed circuit board and mounts them thereon.

2. Description of the Related Art

A surface mounting device is used for quickly and precisely mounting a plurality of parts on a printed circuit board. The construction of the surface mounting device used for mounting parts on a printed circuit board will now be explained with reference to the accompanying drawings. As illustrated in FIG. 1, a surface mounting device 10 includes a X-Y gantry 11, a printed circuit board carrier 12, a module head 13 and a nozzle exchange device 14.

The X-Y gantry 11 is installed in the X-Y direction of the surface mounting device 10, and the module head 13 movable in the X-Y direction is installed on a predetermined portion of the X-Y gantry 11. At the center of the surface mounting device 10, the printed circuit board carrier 12 is installed in the lateral direction. On the printed circuit board carrier 12, the printed circuit board 1 is mounted. When the printed circuit board 1 is carried to a mounting work position (A) by the printed circuit board carrier 12, the module head 13 sucks a parts from a parts feeder 17, moves by a predetermined distance and then mounts the parts on the printed circuit board 1.

The module head 13 is provided with a plurality of nozzle apparatuses 20 as shown in FIG. 2. The nozzle apparatus 20 includes a socket portion 21 and a nozzle portion 22 as shown in FIG. 2. The socket portion 21b, a connection block 21c, a plurality of socket shafts 21d and a plurality of elastic members 21e. The nozzle portion 22 includes a holder 22a and a holder shaft 22b.

The hollow shaft 21a of the socket portion 21 is coupled to the assembly block 21b formed below. The assembly block 21b is mounted on the connection block 21c, and the holder 22a of the nozzle portion 22 is inserted into a predetermined portion inside the connection block 21b. In addition, the plurality of socket shafts 21d and the plurality of elastic members 2le are installed on the bottom of the connection block 21c so that the holder 22a of the nozzle portion 22 can be firmly supported and removed.

The plurality of socket shafts 21d are elastically supported by the plurality of elastic members 21e installed at both sides of the connection block 21c. The socket shafts 21d support both sides of the holder 22a by the elastic force of the elastic members 21e after the holder 22a of the nozzle portion 22 is connected to the connection block 21c. Meanwhile, the holder shaft 22b is formed below the holder 22a of the nozzle portion 22.

When the holder 22a is inserted into the connection block 21c, a nozzle (not shown) is mounted on the holder shaft 22b. In this state, parts are sucked through the nozzle and then mounted on the printed circuit board 1.

In case of exchanging the nozzle portion 22 with another, the socket portion 21 moves to the nozzle exchange device 14 (shown in FIG. 1), puts down the mounted nozzle portion 22, moves in a vertical direction at a high speed to pick up a nozzle portion 22 provided at the nozzle exchange device 14 and then mounts the nozzle portion 22.

In case of exchanging the nozzle portion in the nozzle exchange device, when the socket portion moves in the vertical direction at a high speed and exchanges the nozzle portion with another, there may occur an overshoot or a repetitive error caused by frequent replacement of the nozzle portion.

In addition, in the case that a repetitive error and an overshoot occur, the socket portion may collide with the nozzle exchange device when exchanging the nozzle portion.

### SUMMARY OF THE INVENTION

It is, therefore, an object of the present invention to provide a nozzle apparatus which can maintain accuracy by forming inclined surfaces symmetrically to both sides of a holder on the basis of a center axis of the holder of a nozzle portion when a nozzle portion used for sucking parts in a surface mounting device is inserted and mounted at the insider of a socket portion, be installed closely and mounted at the inside of the socket portion when replacing the nozzle portion.

To achieve the above object, there is provided a nozzle apparatus comprising: a socket portion including an assembly block connected to a hollow shaft, a connection block combined to a lower portion of the assembly block, a plurality of socket shafts installed at both sides of the connection block in order to support a holder of a nozzle portion inserted into the inside of the connection block, and a plurality of elastic members combined to the plurality of sockets in order to supporting the sockets; and the nozzle portion including a holder having a plurality of first inclined surfaces symmetrically formed at its both sides at a predetermined angle in order to be slid the socket shafts, a second inclined surfaces symmetrically formed at the bottom of the first inclined surface at a predetermined angle in order to support the plurality of socket shafts, and an intermediate inclined surface formed between the first and second inclined surfaces with a predetermined angle, and a nozzle formed at a lower portion of the holder in order to suck a parts.

### BRIEF DESCRIPTION OF THE DRAWINGS

The above objects, features and advantages of the present invention will become more apparent from the following detailed description when taken in conjunction with the accompanying drawings, in which:

FIG. 1 is a plane view of a general surface mounting device;

FIG. 2 is a perspective view of a nozzle apparatus as shown in FIG. 1;

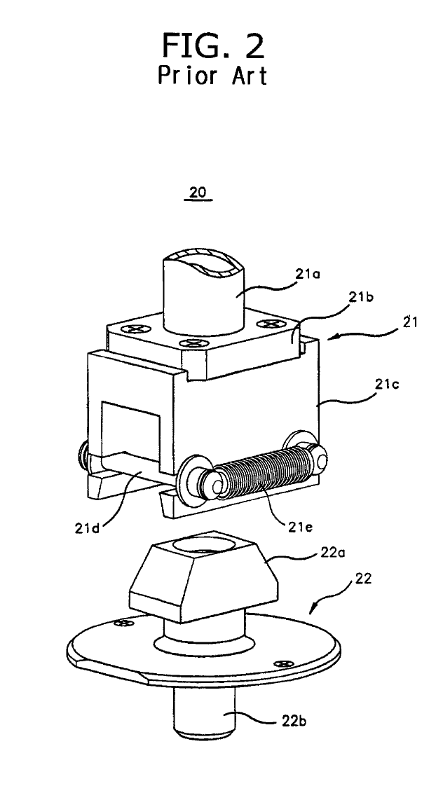

FIG. 3 is a perspective view of a nozzle apparatus according to the present invention;

FIG. 4a is a vertical cross-sectional view of the nozzle apparatus as shown in FIG. 3; and

FIG. 4b is an enlarged cross-sectional view of a connection block portion and a holder portion as shown in FIG. 4a.

### DETAILED DESCRIPTION OF THE PREFERRED EMBODIMENT

A preferred embodiment of the present invention will now be described with reference to the accompanying drawings.

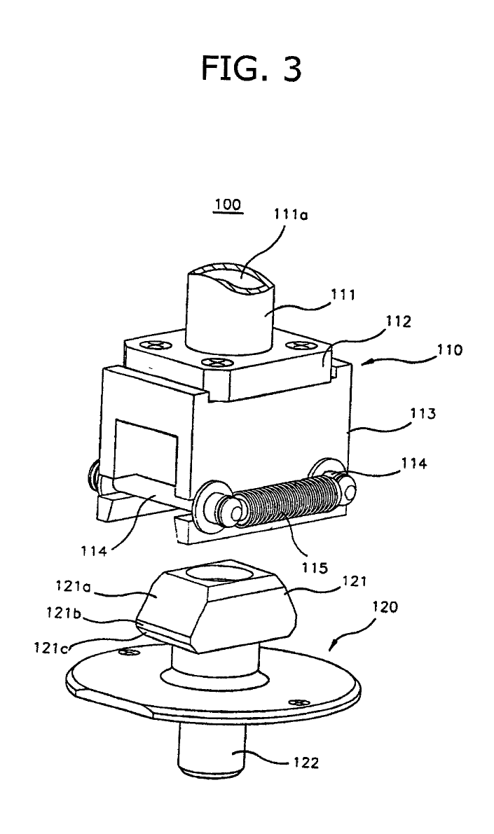

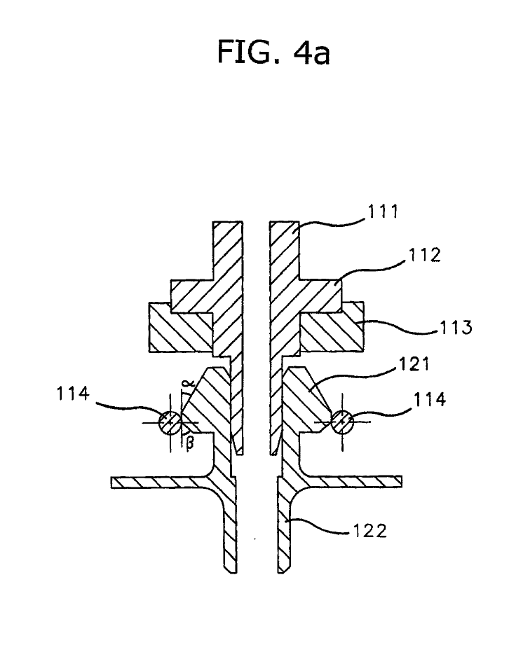

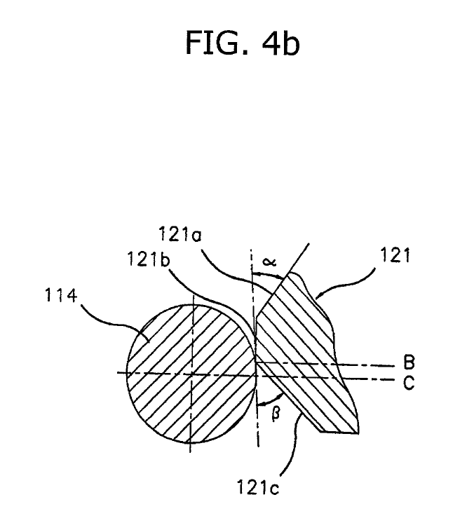

FIG. 3 is a perspective view of a nozzle apparatus according to the present invention. FIG. 4a is a vertical cross-sectional view of the nozzle apparatus as shown in FIG. 3. FIG. 4b is an enlarged cross-sectional view of a connection block portion and a holder portion as shown in FIG. 4a. As illustrated therein, the nozzle apparatus comprises: a socket portion 110 in which a connection block 113 is fixedly installed by an assembly block 112 formed on the bottom of a hollow shaft 111, a plurality of socket shafts 114 are installed at both sides of the connection block 113 and both ends of the socket shaft 114 are connected by a plurality of elastic members 115; and a nozzle portion 120 including a holder 121 having a first inclined surface 121a formed at its both sides at a predetermined angle and a second inclined surface 121b formed at the bottom of the first inclined surface 121a at a predetermined angle, so that it can be inserted into the socket portion 110 and slidably mounted to the inside of the socket portion 110 in a state of contacting with the socket shaft 114 and a holder shaft 122 which is formed on the bottom of the holder 121 and on which a nozzle (not shown) for sucking parts (not shown) is mounted.

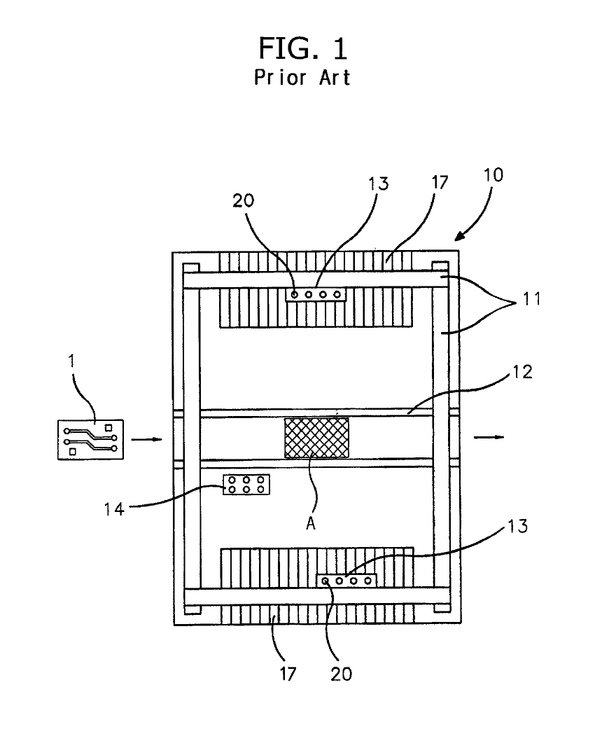

The nozzle apparatus 100 of the present invention includes a socket portion 110 and a nozzle portion 120 as illustrated in FIG. 3. In case of replacing the nozzle portion 120 with another, the socket portion 110 moves to a nozzle exchange device 14 (shown in FIG. 1) provided with the nozzle portion 120 and then moves in the vertical direction at a high speed to exchange the nozzle portion 120 with another.

The socket portion 110 has a hollow shaft 111, an assembly block 112, a connection block 113, a plurality of socket shafts 114 and a plurality of elastic members 115.

The hollow shaft 111 of the socket portion 110 is coupled to the assembly block 112 formed below. In addition, the assembly block 112 is mounted on the connection block 113, the socket shaft 114 is installed at both sides of the connection block 113, and the elastic member 115 is elastically installed at both ends of the socket shaft 114. Here, a penetration groove 11a is formed inside the hollow shaft 11 and an extension spring is used as the elastic member 115.

The nozzle portion 120 is installed inside the connection block 113. The nozzle portion 120 has a holder 121 and a holder shaft 122. The holder 121 is formed in a rectangular hexahedron shape. First and second inclined surfaces 121a and 121c and an intermediate inclined surface 121 formed between the first and second inclined surfaces 121 and 121c are formed at both sides of the holder 121 formed in the rectangular hexahedron shape at a predetermined angle. On the holder shaft 122, a nozzle (not shown) for sucking parts is mounted.

The first and second inclined surfaces 121a and 121c formed at both sides of the holder 121 allows the holder 121 to be slidably inserted into the connection block 113 in the state of contacting with the socket shaft 114 when mounting the holder 121 to the inside of the connection block 113.

The first inclined surface 121a formed at both sides of the holder 121 slopes at an angle of 10˜50° from the vertical axis of the holder 121 as shown in FIGS. 4a and 4b. The second inclined surface 121c formed at the bottom of the first inclined surface 121a slopes at an angle of 30˜50° from the vertical axis of the holder 121.

The intermediate inclined surface 121b between the first and second inclined surfaces 121a and 121c is formed with a predetermined angle of 30˜55° from the vertical axis of the holder 121, so that it can be fixed by the socket shafts 114 contacted with each other by the elastic members 115 in the state that the socket shafts 114 passes the first inclined surface 121a. The second inclined surface 121c formed at the bottom of the intermediate inclined surface 121b, i.e., an edge portion (B) of the holder 121, is formed at a position lower than the center (C) of the socket shafts 114.

When the holder is slidably inserted into the inside of the connection block 113, the socket shafts 114 support the second inclined surface 121c, and resultantly the nozzle portion 120 is mounted on the socket portion 110.

As seen from above, by forming the first and second inclined surfaces at both sides of the holder so that they can be opposed to each other, the holder is supported by the sliding force of the socket shafts contacted with each other by the elastic members when mounting the holder on the socket portion. Therefore, the nozzle portion can be stably replaced with another and mounted on the socket portion regardless of a repetitive error and an overshoot generated when the socket portion moves in a vertical direction at a high speed.

As explained above, the nozzle apparatus of the present invention provides an effect of stably replacing the nozzle portion with another and mounting the same on the socket portion regardless of a repetitive error and an overshoot generated when the socket portion moves in a vertical direction at a high speed by forming the first and second inclined surfaces at both sides of the holder and slidably mounting the same on the socket portion by the socket shafts contacted with each other by the elastic members.

What is claimed is:

1. A nozzle apparatus comprising:
a socket portion including an assembly block connected to a hollow shaft, a connection block combined to a lower portion of the assembly block, a plurality of socket shafts installed at both sides of the connection block in order to support a holder of a nozzle portion inserted into the inside of the connection block, and a plurality of elastic members combined to the plurality of sockets in order to supporting the sockets; and
the nozzle portion including a holder having a plurality of first inclined surfaces symmetrically formed at its both sides at a predetermined angle in order to be slid the socket shafts, a second inclined surfaces symmetrically formed at the bottom of the first inclined surface at a predetermined angle in order to support the plurality of socket shafts, and an intermediate inclined surface formed between the first and second inclined surfaces with a predetermined angle, and a nozzle formed at a lower portion of the holder in order to suck a parts.

2. The nozzle apparatus of claim 1, wherein the first inclined surface is formed at both sides of the holder with an angle of 10˜50° from the vertical axis of the holder.

3. The nozzle apparatus of claim 1, wherein the second inclined surface is formed at the bottom of the first inclined surface at an angle of 30˜50° from the vertical axis of the holder.

4. The nozzle apparatus of claim 1, wherein the intermediate inclined surface is formed with a predetermined angle of 30˜55° from the vertical axis of the holder.
